(19) United States
(12) Patent Application Publication
(10) Pub. No.: US 2022/0373862 A1
(43) Pub. Date: Nov. 24, 2022

(54) CAMERA LENS WITH PROTECTIVE SHELL

(71) Applicant: SHENZHEN JIUPAI INNOVATION TECHNLOGY CO.,LTD., Shenzhen (CN)

(72) Inventor: DONGXING WU, Shenzhen (CN)

(21) Appl. No.: 17/327,656

(22) Filed: May 21, 2021

(51) Int. Cl. G03B 11/04; G02B 7/04

(52) U.S. Cl. CPC G03B 11/043; G02B 7/04

(57) ABSTRACT

The invention relates to the technical field of camera devices and discloses a camera lens with a protective shell. The camera lens comprises a base. A protective shell is disposed on one side of an outer surface of the base and comprises a support plate. A tube is disposed on one side of an outer surface of the support plate. A threaded rod is disposed on one side of an outer surface of the tube. According to the camera lens with a protective shell, the threaded rod drives the connecting plate to move when rotating, then the connecting plate drives the gear lever to move to drive the rotary gears on front and back side to rotate, and then the protective plates rotate around the rotary gears to be opened to allow the camera to be used. In this way, the camera lens is protected.

### BACKGROUND OF THE INVENTION

### 1. Technical Field

The invention relates to the technical field of camera devices, in particular to a camera lens with a protective shell.

### 2. Description of Related Art

The camera lens is the most important part of cameras because its quality has a direct influence on the imaging quality, and it is also one of the most critical criteria for classifying the types and grades of the cameras. Generally speaking, there are three grades of cameras depending on the lens: professional cameras, quasi-professional cameras and ordinary cameras. This classification criterion is suitable for both traditional film cameras and digital cameras. There are two types of lenses: zoom lenses and prime lenses.

With the unceasing change people's life, people are pursuing an ever fulfilling material/spiritual life. A high-quality camera lens, as the most important component parts of cameras, is usually very expensive, but traditional camera lenses are not provided with a protective device and thus may be scratched when used. In view of this, there is an urgent need on the present market for a camera lens with a protective shell to solve the problem that the traditional camera lens is not provided with a protective device.

### BRIEF SUMMARY OF THE INVENTION

### (1) Technical Issue to be Settled

To overcome the defects of the prior art, the invention provides a camera lens with a protective shell which can protect the lens, thus solving the problem, mentioned in the description of the related art, that traditional camera lenses do not have a protection effect.

### (2) Technical Solution

To realize the protection effect on camera lenses mentioned in the description of the related art, the invention provides the following technical solution: a camera lens with a protective shell comprises a base, wherein a protective shell is arranged on one side of an outer surface of the base;

The protective shell comprises a support plate, a tube is disposed on one side of an outer surface of the support plate, a threaded rod is disposed on one side of an outer surface of the tube, a connecting plate is disposed at one end of the threaded rod, a gear lever is disposed on one side of an outer surface of the connecting plate, rotary gears are disposed on one side of an outer surface of the gear lever, a protective plate is disposed on one side of an outer surface of each rotary gear, a slot is formed in one side of the outer surface of the support plate, rotary disks are disposed in the slot, and a power board is fixedly connected to one side of an outer surface of each rotary disk.

Preferably, one end of the tube overlaps with one side of the outer surface of the support plate and penetrates through the side of the outer surface of the support plate to extend into the support plate.

Preferably, one end of the threaded rod overlaps with one side of the outer surface of the tube, penetrates through the side of the outer surface of the tube to reach one side of an inner wall of the tube, and extends to one side of the outer surface of the connecting plate to overlap with the side of the outer surface of the connecting plate.

Preferably, one side of an outer surface of the slot overlaps with one side of the outer surface of the support plate and penetrates through the side of the outer surface of the support plate to extend into the support plate, and one side of the outer surface of the slot is fixedly connected to one side of the outer surface of the tube.

Preferably, a sliding groove is formed in one side of the outer surface of the tube, one side of an outer surface of the sliding groove overlaps one the side of the outer surface of the tube and penetrates through the side of the outer surface of the tube to extend to one side of an inner wall of the tube, and an inner wall of the sliding groove overlaps with the outer surface of the connecting plate.

Support rods are disposed on upper sides of outer surfaces of the rotary gears, rotary rods are disposed on upper sides of outer surfaces of the support rods, and lower ends of the rotary rods overlap with upper sides of the outer surfaces of the support rods, penetrate through the upper sides of the outer surfaces of the support rods to reach lower sides of the outer surfaces of the support rods, extend to the upper sides of the outer surfaces of the rotary gears to overlap with the upper sides of the outer surfaces of the rotary gears, then penetrate through the upper sides of the outer surfaces of the rotary gears to reach lower sides of the outer surfaces of the rotary gears, and finally extend to the upper sides of the outer surfaces of the lower sides of the support rods, so that the rotary gears drive the protective plates to move.

Preferably, the base comprises a first focusing tube, a second focusing tube is disposed on one side of an outer surface of the first focusing tube, and a third focusing tube is disposed on one side of an outer surface of the second focusing tube.

Preferably, a first sliding groove is formed in one side of an inner wall of the second focusing tube, one side of an outer surface of the first sliding groove overlaps with one side of the inner wall of the second focusing tube and penetrates through the side of the inner wall of the second focusing tube to extend into the second focusing tube, an inner wall of the first sliding groove overlaps with a first sliding bar, and a lower end of the first sliding bar is fixedly connected to an upper side of the outer surface of the first focusing tube.

Preferably, a second sliding groove is formed in one side of an inner wall of the third focusing tube, one side of an outer surface of the second sliding groove overlaps with one side of the inner wall of the third focusing tube and penetrates through the side of the inner wall of the third focusing tube to extend into the third focusing tube, an inner wall of the second sliding groove overlaps with a second sliding bar, and a lower end of the second sliding bar is fixedly connected to an upper side of the outer surface of the second focusing tube.

Compared with the prior art, the camera lens with a protective shell of the invention has the following beneficial effects:

1. According to the camera lens with a protective shell, the threaded rod disposed in the protective shell drives the connecting plate to move when rotating, then the connecting plate drives the gear lever to move to drive the rotary gears on front and back sides to rotate, and then the protective plates rotate around the rotary gears to be opened to allow the camera to be used; in this way, the camera lens is protected.

2. According to the camera lens with a protective shell, the slot is formed in the protective shell, the rotary disks are disposed in the slot, and a remote control device is disposed below the outer surfaces of the rotary disks; when the remote control device is started, the rotary disks drive the power boards to rotate; when the power boards overlap with one side of the outer surface of the connecting plate, the protective boards are opened or closed.

3. According to the camera lens with a protective shell, by means of the first sliding groove and the second sliding groove formed in the base, the first focusing tube, the second focusing tube and the third focusing tube can stretch or retreat to facilitate focusing of a camera.

The invention relates to the technical field of camera devices and discloses a camera lens with a protective shell. The camera lens comprises a base. A protective shell is disposed on one side of an outer surface of the base and comprises a support plate. A tube is disposed on one side of an outer surface of the support plate. A threaded rod is disposed on one side of an outer surface of the tube. A connecting plate is disposed at one end of the threaded rod. A gear lever is disposed on one side of an outer surface of the connecting plate. Rotary gears are disposed on one side of an outer surface of the gear lever. A protective plate is disposed on one side of an outer surface of each rotary gear. A slot is formed in one side of the outer surface of the support plate. Rotary disks are disposed in the slot. According to the camera lens with a protective shell, the threaded rod drives the connecting plate to move when rotating, then the connecting plate drives the gear lever to move to drive the rotary gears on front and back side to rotate, and then the protective plates rotate around the rotary gears to be opened to allow the camera to be used. In this way, the camera lens is protected.

### BRIEF DESCRIPTION OF THE SEVERAL VIEWS OF THE DRAWINGS

FIG. 1 is a front structural view of the invention;

FIG. 2 is a top sectional view of a protective shell of the invention;

FIG. 3 is a front sectional view of a base of the invention.

Reference signs: 1, base; 2, protective shell; 101, first focusing tube; 102, second focusing tube; 103, third focusing tube; 104, first sliding groove; 105, first sliding bar; 106, second sliding groove; 107, second sliding bar; 201, support plate; 202, tube; 203, threaded rod; 204, connecting plate; 205, gear lever; 206, rotary gear; 207, protective plate; 208, slot; 209, rotary disk; 210, power board.

### DETAILED DESCRIPTION OF THE INVENTION

The technical solution of the embodiments of the invention will be clearly and completely described below in conjunction with the accompanying drawings of the embodiments. Obviously, the embodiments in the following description are merely illustrative ones, and are not all possible ones of the invention. All other embodiments obtained by those ordinarily skilled in the art based on the following ones without creative labor should also fall within the protection scope of the invention.

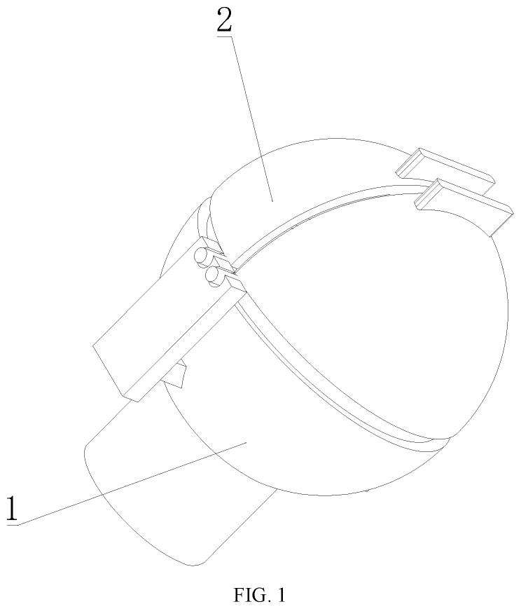

Referring to FIG. 1-FIG. 3, a camera lens with a protective shell comprises a base 1;

As shown in FIG. 1, a protective shell 2 is disposed on one side of an outer surface of the base 1;

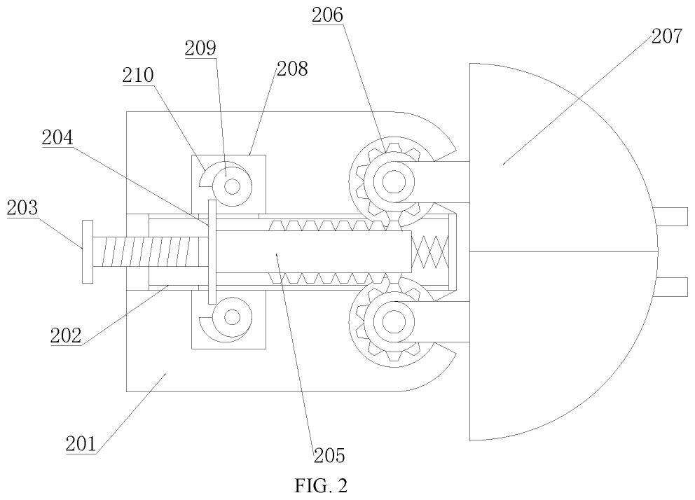

As shown in FIG. 2, the protective shell 2 comprises a support plate 201, wherein a tube 202 is disposed on one side of an outer surface of the support plate 201, a threaded rod 203 is disposed on one side of an outer surface of the tube 202, a connecting plate 204 is disposed at one end of the threaded rod 203, a gear lever 205 is disposed on one side of an outer surface of the connecting plate 204, rotary gears 206 are disposed on one side of an outer surface of the gear lever 205, a protective plate 207 is disposed on one side of an outer surface of each rotary gear 206, a slot 208 is formed in one side of the outer surface of the support plate 201, rotary disks 209 are disposed in the slot 208, and a power board 210 is fixedly connected to one side of an outer surface of each rotary disk 209.

Specifically, as shown in FIG. 2, one end of the tube 202 overlaps with one side of the outer surface of the support plate 201 and penetrates through the side of the outer surface of the support plate 201 to extend into the support plate 201.

Specifically, as shown in FIG. 2, one end of the threaded rod 203 overlaps with one side of the outer surface of the tube 202, penetrates through the side of the outer surface of the tube 202 to reach one side of an inner wall of the tube 202, and extends to one side of the outer surface of the connecting plate 204 to overlap with the side of the outer surface of the connecting plate 204.

Specifically, as shown in FIG. 2, one side of an outer surface of the slot 208 overlaps with one side of the outer surface of the support plate 201 and penetrates through the side of the outer surface of the support plate 201 to extend into the support plate 201, and one side of the outer surface of the slot 208 is fixedly connected to one side of the outer surface of the tube 201.

Specifically, as shown in FIG. 2, a sliding groove is formed in one side of the outer surface of the tube 202, one side of an outer surface of the sliding groove overlaps with one side of the outer surface of the tube 202 and penetrates through the side of the outer surface of the tube 202 to reach one side of the inner wall of the tube 202, and an inner wall of the sliding groove overlaps with the outer surface of the connecting plate 204.

According to the above technical solution, support rods are disposed on upper sides of outer surfaces of the rotary gears 206, rotary rods are disposed on upper sides of outer surfaces of the support rods, and lower ends of the rotary rods overlap with upper sides of the outer surfaces of the support rods, penetrate through the upper sides of the outer surfaces of the support rods to reach lower sides of the outer surfaces of the support rods, extend to the upper sides of the outer surfaces of the rotary gears 206 to overlap with the upper sides of the outer surfaces of the rotary gears 206, then penetrate through the upper sides of the outer surfaces of the rotary gears 206 to reach lower sides of the outer surfaces of the rotary gears 206, and finally extend to the upper sides of the outer surfaces of the lower sides of the support rods, so that the rotary gears 206 can drive the protective plates 207 to move.

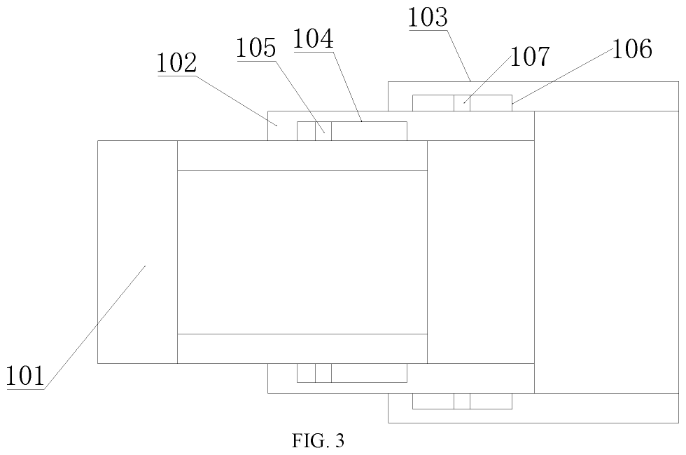

Specifically, as shown in FIG. 3, the base 1 comprises a first focusing tube 101, wherein a second focusing tube 102 is disposed on one side of an outer surface of the first focusing tube 101, and a third focusing tube 103 is disposed on one side of an outer surface of the second focusing tube 102.

Specifically, as shown in FIG. 3, a first sliding groove 104 is formed in one side of an inner wall of the second focusing tube 102, one side of an outer surface of the first sliding groove 104 overlaps with one side of the inner wall of the second focusing tube 102 and penetrates through the side of the inner wall of the second focusing tube 102 to extend into the second focusing tube 102, an inner wall of the first sliding groove 104 overlaps with a first sliding bar 105, and a lower end of the first sliding bar 105 is fixedly connected to an upper side of the outer surface of the first focusing tube 101.

Specifically, as shown in FIG. 3, a second sliding groove 106 is formed in one side of an inner wall of the third focusing tube 103, one side of an outer surface of the second sliding groove 106 overlaps with one side of the inner wall of the third focusing tube 103 and penetrates through the side of the inner wall of the third focusing tube 103 to extend into the third focusing tube 103, an inner wall of the second sliding groove 106 overlaps with a second sliding bar 107, and a lower end of the second sliding bar 107 is fixedly connected to an upper side of the outer surface of the second focusing tube 102.

When the camera lens with a protective shell is used, the rotary disks 209 are made to rotate by rotating the threaded rod 203 or through a remote control device, and then the rotary disks 209 drive the power boards 210 to rotate; when one side of the outer surface of each power board 210 overlaps with one side of the outer surface of the connecting plate 204, and the connecting plate 204 drives the gear rod 205 to move to enable the rotary gears 206 on the front and back sides to rotate to open or close the protective plates 207.

Although the embodiments of the invention have been illustrated and described above, those ordinarily skilled in the art would appreciate that different variations, amendments, substitutions and transformations can be made to these embodiments without departing from the principle and spirit of the invention. The scope of the invention should be defined by the appended claims and their equivalents.

What is claimed is:

1. A camera lens with a protective shell, comprising a base (1), wherein a protective shell (2) is disposed on a side of an outer surface of the base (1);
the protective shell (2) comprises a support plate (201), a tube (202) is disposed on a side of an outer surface of the support plate (201), a threaded rod (203) is disposed on a side of an outer surface of the tube (202), a connecting plate (204) is disposed at an end of the threaded rod (203), a gear lever (205) is disposed on a side of an outer surface of the connecting plate (204), rotary gears (206) are disposed on a side of an outer surface of the gear lever (205), a protective plate (207) is disposed on a side of an outer surface of each said rotary gear (206), a slot (208) is formed in a side of the outer surface of the support plate (201), rotary disks (209) are disposed in the slot (208), and a power board (210) is fixedly connected to a side of an outer surface of each said rotary disk (209).

2. The camera lens with a protective shell according to claim 1, wherein an end of the tube (202) overlaps with a side of the outer surface of the support plate (201) and penetrates through the side of the outer surface of the support plate (201) to extend into the support plate (201).

3. The camera lens with a protective shell according to claim 1, wherein an end of the threaded rod (203) overlaps with a side of the outer surface of the tube (202), penetrates through the side of the outer surface of the tube (202) to reach a side of an inner wall of the tube (202), and extends to a side of the outer surface of the connecting plate (204) to overlap with the side of the outer surface of the connecting plate (204).

4. The camera lens with a protective shell according to claim 1, wherein a side of an outer surface of the slot (208) overlaps with a side of the outer surface of the support plate (201) and penetrates through the side of the outer surface of the support plate (201) to extend into the support plate (201), and a side of the outer surface of the slot (208) is fixedly connected to a side of the outer surface of the tube (202).

5. The camera lens with a protective shell according to claim 1, wherein a sliding groove is formed in a side of the outer surface of the tube (202), a side of an outer surface of the sliding groove overlaps a the side of the outer surface of the tube (202) and penetrates through the side of the outer surface of the tube (202) to extend to a side of an inner wall of the tube (202), and an inner wall of the sliding groove overlaps with the outer surface of the connecting plate (204).

6. The camera lens with a protective shell according to claim 1, wherein the base (1) comprises a first focusing tube (101), a second focusing tube (102) is disposed on a side of an outer surface of the first focusing tube (101), and a third focusing tube (103) is disposed on a side of an outer surface of the second focusing tube (102).

7. The camera lens with a protective shell according to claim 6, wherein a first sliding groove (104) is formed in a side of an inner wall of the second focusing tube (102), a side of an outer surface of the first sliding groove (104) overlaps with a side of the inner wall of the second focusing tube (102) and penetrates through the side of the inner wall of the second focusing tube (102) to extend into the second focusing tube (102), an inner wall of the first sliding groove (104) overlaps with a first sliding bar (105), and a lower end of the first sliding bar (105) is fixedly connected to an upper side of the outer surface of the first focusing tube (101).

8. The camera lens with a protective shell according to claim 6, wherein a second sliding groove (106) is formed in a side of an inner wall of the third focusing tube (103), a side of an outer surface of the second sliding groove (106) overlaps with a side of the inner wall of the third focusing tube (103) and penetrates through the side of the inner wall of the third focusing tube (103) to extend into the third focusing tube (103), an inner wall of the second sliding groove (106) overlaps with a second sliding bar (107), and a lower end of the second sliding bar (107) is fixedly connected to an upper side of the outer surface of the second focusing tube (102).
